(19) United States
(12) Patent Application Publication
(10) Pub. No.: US 2010/0077472 A1
(43) Pub. Date: Mar. 25, 2010

(54) Secure Communication Interface for Secure Multi-Processor System

(75) Inventors: Majid Kaabouch, Rousset (FR); Eric Le Cocquen, Saint Maximin La Sainte Baume (FR)

Correspondence Address: FISH & RICHARDSON P.C., PO BOX 1022, MINNEAPOLIS, MN, 55440-1022, US

(73) Assignee: ATMEL Corporation

(21) Appl. No.: 12/236,434

(22) Filed: Sep. 23, 2008

(51) Int. Cl. G06F 21/00; G06F 15/163; G06F 9/00

(52) U.S. Cl. 726/16; 712/28; 712/E09.001

(57) ABSTRACT

A secure communication interface for a secure multi-processor system is disclosed. The secure communication interface can include a secure controller that is operable to transfer data between a first memory that is directly accessible by a first (master) processor and a second memory that is directly accessible by a secure second (slave) processor in the multi-processor system. One or more control and status registers accessible by the processors facilitate secure data transfer between the first memory and a memory window defined in the second memory. One or more status and violation registers shared by the processors can be included in the secure communication interface for facilitating secure data transfer and for reporting security violations based on a rule set.

### RELATED APPLICATION

This subject matter is generally related to U.S. patent application Ser. No. 11/558,367, for “Bi-Processor Architecture For Secure Systems,” filed Nov. 9, 2006, which patent application is incorporated by reference herein in its entirety.

### TECHNICAL FIELD

This subject matter is generally related to secure multi-processor architectures.

### BACKGROUND

Secure integrated circuit cards, commonly referred to as smart cards, are often used in applications where sensitive information is to be stored and shared. Set-top boxes that facilitate pay-per-view or video-on-demand features may use a smart card to supply user account information to a provider along with a request for access to such features, and to subsequently decrypt encrypted digital video streams that may be provided in response to the request. A Subscriber Identity Module (SIM) card in a Global Systems for Mobile Communications (GSM) phone may be used to store a user's personal information, such as his or her phone book, device preferences, preferred network(s), saved text or voice messages and service provider information. Smart cards may be used in a variety of other applications, including but not limited to electronic payment systems, specialized auto-debit devices, personal identification documents, medical identification cards, etc.

Due to security concerns, encryption standards or algorithms may be used to protect sensitive information on a smart card. For example, the Digital Encryption Standard (DES) may be used to encrypt information with a 56-bit key. Access to private data may only be available to a holder of the key. Newer updates to this standard, such as Triple-DES and Advanced Encryption Standard (AES) may offer an even more complex (and secure) encryption key algorithm. Another example standard is RSA (an acronym derived from the surnames of its three creators-Rivest, Shamir and Adleman), a public key encryption standard with private-key decryption. Because of the value of information that may be stored on and protected by a smart card, hackers may employ various techniques to break or bypass various encryption algorithms used to protect sensitive information on a smart card. These techniques may generally be categorized as invasive attacks and non-invasive attacks.

For example, a hacker may grind off a portion of the smart card packaging to access internal signals and bypass security measures that may be in place. As another example, a hacker may subject the smart card to various kinds of radiation (e.g., laser light directed to exposed internal circuits or x-ray or gamma radiation directed through packaging) in an attempt to corrupt protected data. In some implementations, corruption of protected data at certain locations in the device can cause the device to bypass security measures (e.g., encryption algorithms) or to yield information to the hacker regarding device architecture or the protected data itself.

Smart cards can also be subject to attacks such as code reverse engineering. In a reverse engineering attack, the goal of a hacker is to study embedded instructions and data (or “code”) in the smart card memory to clone the smart card functionality on an easily available programming device. Hardware countermeasures such as memory encryption and implanted read-only memories (ROMs) are commonly implemented on secure microcontrollers to prevent such code reverse engineering. However, the smart card's central processing unit (CPU) typically has unencrypted access to the entire program memory contents and can be manipulated to output the entire contents of memory. Once sensitive information has been extracted from a device, the information can be used for various nefarious purposes. For example, a hacker can obtain pay-per-view or video-on-demand services using another user's account, the hacker can access telecommunication services that are billed to another user, the hacker can steal another user's bank account funds; the hacker can steal another's identity, etc.

Conventional smart card systems include a single processor to manage sensitive tasks and non-critical tasks such as data exchange with external systems. These conventional smart cards use hardware (e.g., a hardware firewall) and software protections to provide a secure barrier between sensitive and non-critical tasks. This barrier, however, is subject to hacker attacks with the intention of extracting critical information (e.g., cryptographic keys).

### SUMMARY

A secure communication interface for a secure multi-processor system is disclosed. The secure communication interface can include a secure controller that is operable to transfer data between a first memory that is directly accessible by a first (master) processor and a second memory that is directly accessible by a secure second (slave) processor in the multi-processor system. One or more control and status registers accessible by the processors facilitate secure data transfer between the first memory and a memory window defined in the second memory. One or more status and violation registers shared by the processors can be included in the secure communication interface for facilitating secure data transfer and for reporting security violations based on a rule set.

The secure communication interface provides a secure communication path between one or more secure, slave processors and associated data memories for processing and storing sensitive information, and one or more master processors and associated data memories for processing and storing requests from external systems. The secure communication interface prevents a master processor from directly reading or modifying data in a memory directly accessible by a secure, slave processor or to dump secure program code from the memory when attacked by an external system.

The secure communication interface prevents a slave processor from transferring secure data to an external system when attacked by an external system.

The secure communication interface performs fast and secure data transfer between master and slave processors without using the processors' resources, thus the processors can perform other tasks or operations in parallel with the data transfer.

### DESCRIPTION OF DRAWINGS

FIG. 1 is a block diagram of an example multi-processor system using a secure communication interface.

FIGS. 2A and 2B are block diagrams of example smart cards that can be used to implement multi-processor system of FIG. 1.

FIG. 3 is a flow diagram of an example process for communicating with a slave CPU.

FIG. 4 is a block diagram of an example secure communication interface for use in the secure multi-processor system of FIG. 1.

FIG. 5 is a schematic diagram of the example secure controller of FIG. 4.

FIG. 6 is a flow diagram of an example secure data transfer using the secure controller of FIG. 5.

FIG. 7 is a block diagram of a more detailed example of the data transfer process of FIG. 6 using control and status registers.

### DETAILED DESCRIPTION

### System Overview

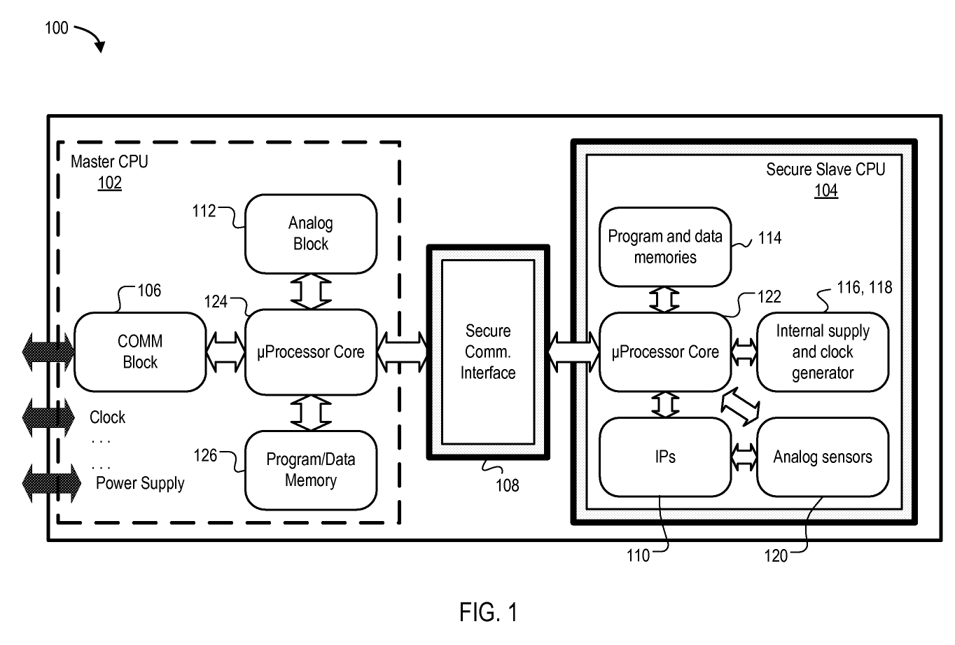

FIG. 1 is a block diagram of an example multi-processor system using a secure communication interface. In some implementations, a multi-processor system 100 includes a master CPU 102 and a secure slave CPU 104. The master CPU 102 is used to perform tasks that do not require sensitive information, such as data transfer to an external system through a communication block 106. The slave CPU 104 is used to perform tasks that manipulate sensitive information. In some implementations, the master CPU 102 processes external requests received through the communication block 106 and assigns resulting tasks involving manipulation of sensitive information to the slave CPU 104 using a secure communication interface 108.

In some implementations, the master CPU 102 and/or the slave CPU 104 include intrusion prevention systems 110 (“IPs”) that can be customized to specific applications. An analog block 112 can include general analog hacker safeguards, such as a frequency monitor, a power supply monitor, a temperature sensor, and a voltage regulator. The master CPU 102 can include one or more microprocessor cores 124 and program and data memory 126 (hereinafter also referred to as “data memory 126”), and the slave CPU 104 can include one or more microprocessor cores 122 and program and data memory 114 (hereinafter also referred to as “data memory 114”)

The slave CPU 104, which handles sensitive information, can be protected by a hardware shield that includes protections that isolate the slave CPU 104 from the master CPU 102 or from external systems. A separate power supply 116 can provide galvanic isolation from the external system's power supply but also from the master CPU 102 and the remainder of the chip power supply. The separate power supply 116 prevents power glitches applied on an external pin from propagating to the slave CPU 104. A separate clock system 118 prevents clock glitches from propagating to the slave CPU 104 and allows the slave CPU 104 to participate in anti differential power analysis counter measures. A separate program and data memory 114 in the slave CPU 104 prevents the master CPU 102 from reading or modifying sensitive information on the slave CPU 104 directly or when under attack. In some implementations, the data memory 114 can include parity bits which allow for the detection of fault injection attacks on the data memory 114. Dedicated analog sensors 120 monitor the slave CPU 104's environmental conditions for signs of attack. A physical shield (e.g., a metallic cover not shown) enclosing the slave CPU 104 and, optionally, the master CPU 102, can reduce the likelihood that a hacker will gain access to internal signals or subject the slave CPU 104 to various kinds of radiation in an attempt to corrupt sensitive information.

In some implementations, data exchange between the master CPU 102 and the slave CPU 104 can be managed through the secure communication interface 108. The master CPU 102 can also place processing requests for the slave CPU 104 through the secure communication interface 108. Such requests can be received “as is” from external systems and the master CPU 102 would, in this case, be used as a simple mailbox. In some implementations, the master CPU 102 has no access to processing methods or information within the slave CPU 104. The slave CPU 104 processes the request and transfers results (if any) to the master CPU 102 through the secure interface 108.

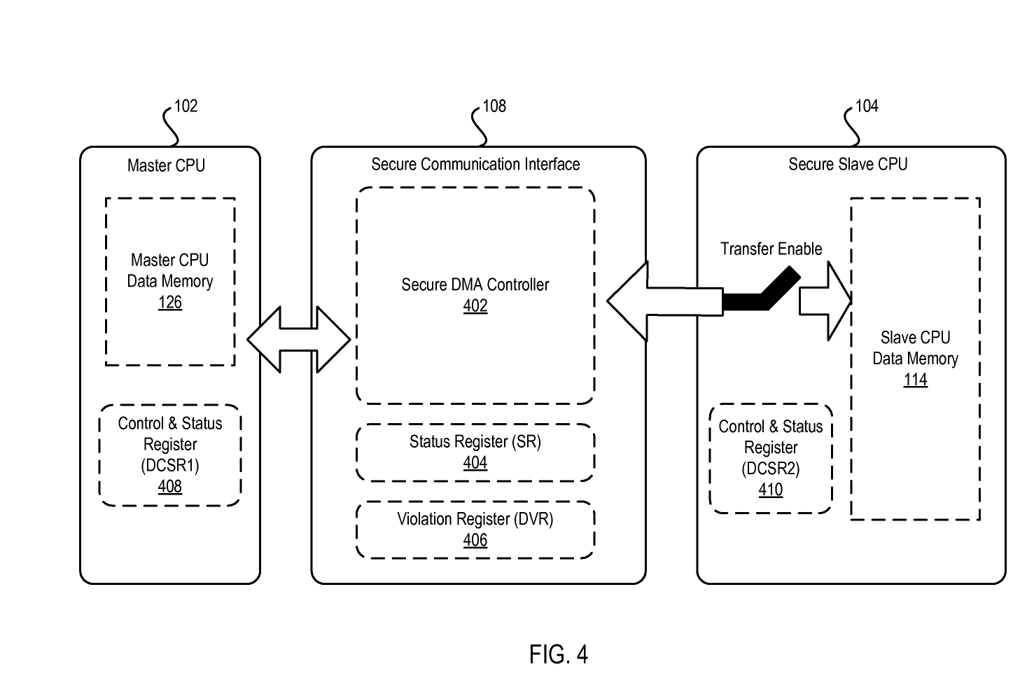

In some implementations, the secure communication interface 108 can also include status registers, control registers, or combinations of these, as described in reference to FIG. 4. To prevent the slave CPU 104 from being vulnerable to hacker attacks through these registers, in some implementations the read/write access to these registers is defined such that any link between the two processors only serves the purpose of exchanging input data and output results. In these implementations, the master CPU 102 is not capable of controlling the slave CPU 104 through the registers. In some implementations, the interaction between the processors 102, 104 is strictly limited to transmitting information to be processed and getting the result back.

In some implementations, a secure communication protocol is implemented to guarantee a secure communication between the master CPU 102 and the slave CPU 104 over the secure communication interface 108. Data sent by the master CPU 102 to the slave CPU 104 through the secure interface 108 can be signed to allow the slave CPU 104 to verify the integrity of the data before processing the data. Moreover, data sent by the slave CPU 104 to the master CPU 102 can likewise be digitally signed. In some implementations, a request from the master CPU 102 to the slave CPU 104 is encrypted with keys known by the slave CPU 104. Similarly, responses to requests can be digitally signed, encrypted or both and returned to the master CPU 102 for transmission to external systems, such that the master CPU 102 acts as a passive conduit between the slave CPU 104 and the external systems.

### Example Smart Card Systems

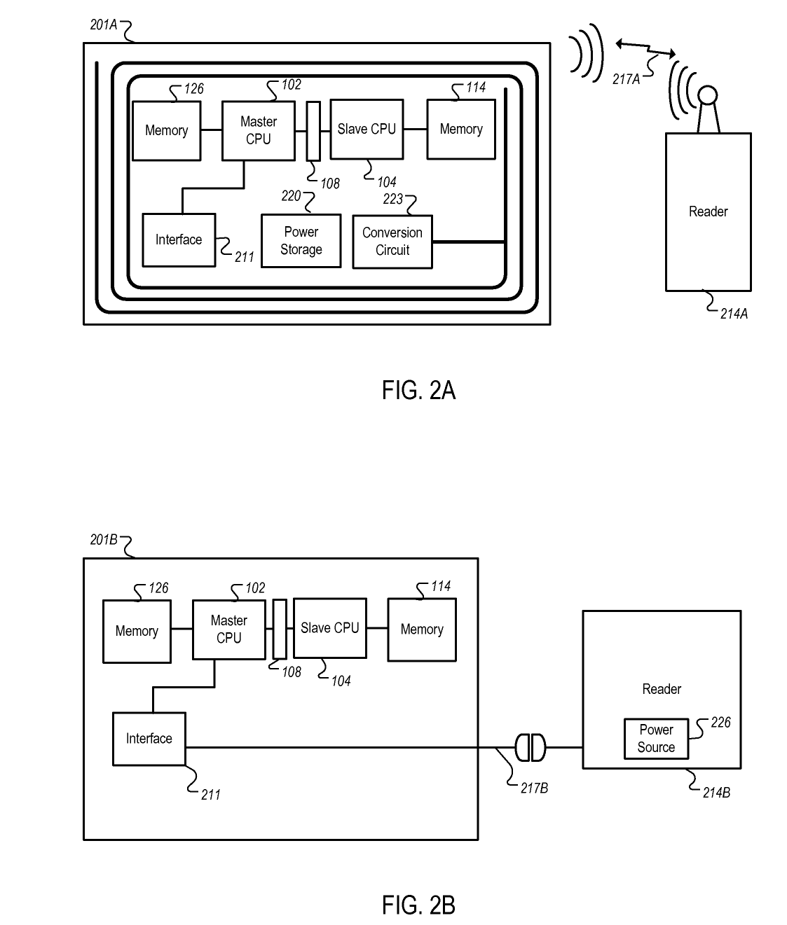

FIGS. 2A and 2B are block diagrams of example smart cards 201A and 201B that can be used to implement the multi-processor system 100. As shown, each example smart card 201A, 201B includes a master CPU 102, a slave CPU 104 and a secure communication interface 108 between the two. Each CPU 102, 104 has its own memory. In the example shown, the master CPU 102 has a memory 126 and the slave CPU 104 has a memory 114. The master CPU 102 cannot access the slave CPU 104 memory 114. Memories 126, 114 can represent multiple different kinds of memory, such as, for example, ROM or RAM, flash, DRAM, SRAM, etc. In some implementations, program instructions for the master CPU 102 are stored on non-volatile memory (e.g., ROM), and the master CPU 102 uses some form of volatile memory (e.g., RAM) to store intermediate data as the programming instructions are executed.

An interface 211 provides a means for the smart cards 201A or 201B to interact with external systems, such as, for example, a smart card reader 214A or 214B. In some implementations, the interface 211 works in conjunction with a wireless communication channel 217A that includes, for example, radio frequency (RF) signals that are adapted for a particular communication protocol (e.g., a protocol characterized by ISO/IEC 14443 or ISO 15693). In some implementations, the interface 211 works in conjunction with a wired communication channel 217B that is adapted for a particular communication protocol (e.g., a protocol characterized by ISO/IEC 7816 or ISO/IEC 7810).

The smart cards 201A or 201B are powered by a power source. For example, the smart card 201A can be powered by an integrated power storage device 220, such as a battery or low-loss capacitor. As another example, the smart card 201A can be powered by an antenna and conversion circuit 223 that receives RF signals and converts energy in the RF signals to electrical energy that can be used to power the components of the smart card 201A. As another example, the smart card 201B can be powered by a source that is external to the smart card itself, such as a power supply 226 that is integrated in a corresponding smart card reader 214B.

In operation, the smart card reader 214A or 214B can request protected information from the smart card 201A or 201B, respectively. In some implementations, the smart card reader 214A or 214B provides an encryption key for the smart card 201A or 201B to use in encrypting the protected information before transmitting it to the reader 214A or 214B. In some implementations, the protected information is already stored in encrypted form, and the smart card 201A or 201B provides a decryption key for the smart card reader 214A or 214B to use in decrypting the protected information. In some implementations, the smart card 201A or 201B performs other operations on the protected information. Smart cards can also include other intrusion prevention systems such as timers, cryptography processors, cryptography accelerators, etc.

### Example Process For Communicating With Slave CPU

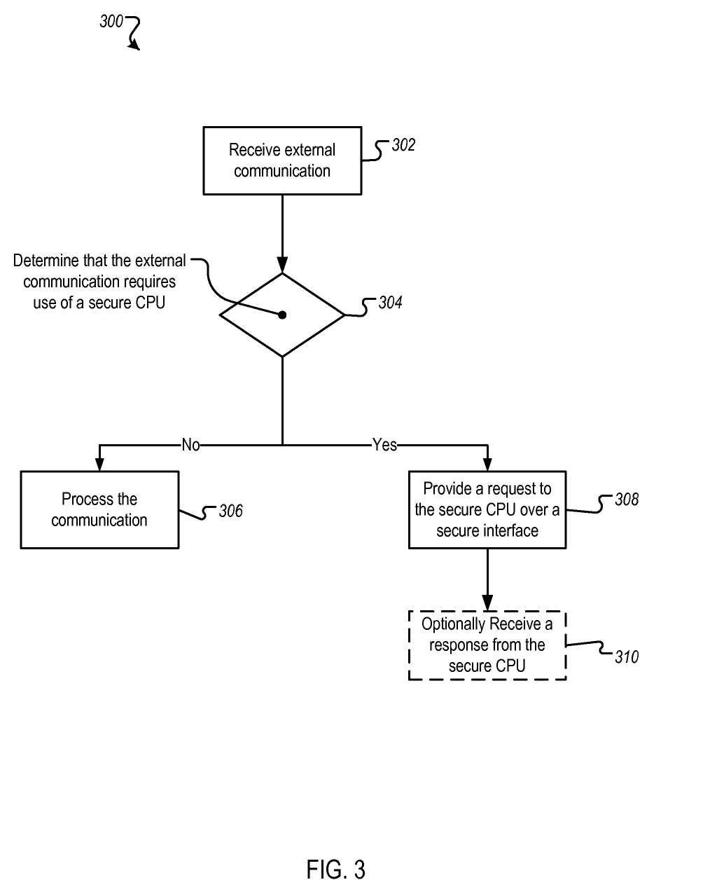

FIG. 3 is a flow chart of a process 300 for communicating with a slave CPU. A master CPU (e.g., 102) receives an external communication from a communication block (e.g., 106; step 302). The master CPU determines whether or not the external communication requires use of a secure CPU (e.g., 104), such as when sensitive information is to be manipulated (step 304). For example, if the external communication is encrypted, the master CPU can assume that the secure CPU can decrypt and process the communication. If the communication does not require the secure CPU, the master CPU processes the communication (step 306). Otherwise, a request is provided to the secure CPU over a secure communication interface (e.g., 108) for the secure CPU to process the external communication or perform some task based on the external communication (step 308). An optional response is received from the secure CPU (step 310) which can be further processed by the master CPU or provided in some form to external systems through the communication block (e.g., communication block 106).

### Secure Communication Interface

FIG. 4 is a block diagram of an example secure communication interface for use in the secure multi-processor system 100 of FIG. 1. In some implementations, a secure communication interface 108 can include a secure controller 402 (e.g., a Direct Memory Access controller), status register 404 and violation register 406. The secure communication interface 108 allows secure internal communication between the master CPU 102 and the slave CPU 104 by allowing the exchange of requests and providing software and hardware isolation of the data memory 114 of the slave CPU 104.

In some implementations, the master CPU 102 and the secure slave CPU 104 exchange requests (e.g., interrupt requests) through the secure communication interface 108, which is responsible for managing communication between the two processors. The control and status registers 408, 410, located in the master CPU 102 and secure slave CPU 104, respectively, allow each processor to send a request to the other processor.

In conventional single processor systems, data transfer is often performed by a single CPU using move software instructions. This method, however, can be subject to fault injection attacks (e.g., laser attacks, glitch attacks) that can change the address operand of move instructions and then force the CPU to transfer sensitive information to an external system. The secure communication interface 108 addresses this security flaw by controlling data transfer between the slave CPU 104 and the master CPU 102. For example, data transfer can be supervised by the slave CPU 104 which can terminate the transfer using a transfer enable control signal or other mechanism. The secure controller 402 makes data exchange more secure as the hardware secure communication interface 108 is more robust to fault injection attacks than software move instructions used by convention secure systems. Moreover, data transfer between processors in a multi-processor system can be digitally signed or otherwise encrypted to increase data transfer robustness.

To increase immunity of the slave CPU 104 to external attacks, software data moved from the slave CPU 104 to the master CPU 102 can be physically forbidden by set of rules. A first rule specifies that data memory 126 directly accessible by the master CPU 102 must not be accessible by (“visible”) to the slave CPU 104. For example, the program code executed by the slave CPU 104 cannot be allowed to fetch instructions or read data from the data memory 126 directly accessible by the master CPU 102. Likewise, the slave CPU 104 cannot use software instructions to transfer sensitive information to external systems, except for reading and writing to a status register 404 and a violation register 406 in the secure communication interface 108 which are shared between the processors 102, 104. Only the secure controller 402 can access the data memory 114 of the slave CPU 104 for data exchange operations. Second, the data memory 114 of the slave CPU 104 must not be directly accessible by the master CPU 102. For example, the program code executed by the master CPU 102 cannot address the data memory 114 of the slave CPU 104. Based on these foregoing rules, the slave CPU 104 cannot directly access the data memory 126 of the master CPU 102. Likewise, the master CPU 102 cannot directly access the data memory 114 of the slave CPU 104.

### Secure Controller Architecture

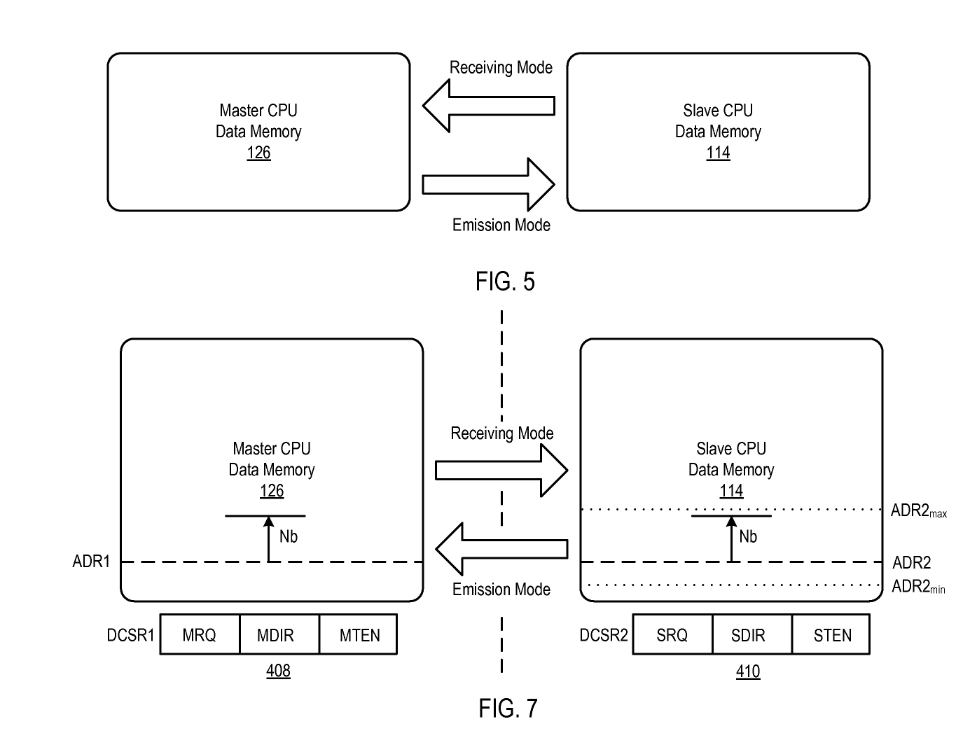

FIG. 5 is a schematic diagram of the example secure controller 402 of FIG. 4. In some implementations, the secure controller 402 processes data exchanged between the data memory 114 of the slave CPU 104 and the data memory 126 of the master CPU 102. To perform a data exchange, the secure controller 402 reads the data memory 114 of the slave CPU 104 and writes the data memory 126 of the master CPU 102. These operations can be subject to attack as sensitive information located in the data memory 114 can be dumped and stored into the data memory 126, then subsequently transferred to an external system. The secure controller 402 also reads the data memory 126 of the master CPU 102 and writes the data memory 114 of the slave CPU 104. These operations must also be protected to prevent any data write to non-authorized portions of data memory 114 of the slave CPU 104.

In some implementations, the secure controller 402 can be configured in emission mode or receiving mode. In emission mode, the secure controller 402 can read the data memory 114 of the slave CPU 104 and write the data memory 126 of the master CPU 102. In receiving mode, the secure controller 402 can read the data memory 126 of the master CPU 102 and write the data memory 114 of the slave CPU 104. The secure controller 402 can be controlled by Input/Output (I/O) control registers as described in reference to FIG. 7.

### Example Data Transfer Process

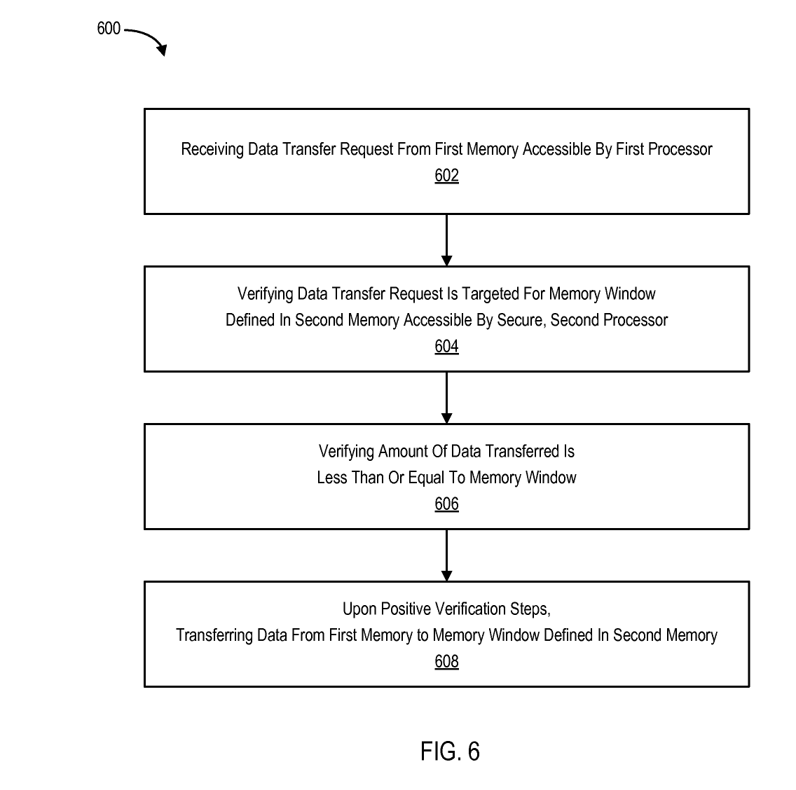

FIG. 6 is a flow diagram of an example secure data transfer process 600 using a secure controller (e.g., the secure controller 402). In some implementations, the process 600 begins when the secure controller in a secure communication interface of a multi-processor system receives a data transfer request from a first memory (e.g., memory 126) directly accessible a first processor (602) (e.g., master CPU 102). The secure controller verifies that the data transfer is targeted to a memory window defined in a second memory (e.g., memory 114) directly accessible by a secure, second processor (e.g., secure slave CPU 104) in the multi-processor system (604). The secure controller verifies that the amount of data subject to transfer is less than or equal to the size of the memory window (606). For example, if a number of bytes of data subject to transfer exceeds Nb bytes, then a security violation will be reported (e.g., reported in the violation register 406). Upon positive verification of steps 604, 606, data is transferred from the first memory to the memory window defined in the second memory (608).

### Example Control & Status Register Operations

FIG. 7 is a block diagram of a more detailed example of the data transfer process of FIG. 6 using control and status registers. In some implementations, one or more registers in the processors 102, 104 can be used to control data exchange between the processors 102, 104. In this example, a register Nb represents a number of bytes of data to transfer between data memories 126, 114 of the processors 102, 114, respectively, when the secure controller 402 is configured in receiving or emission mode. The register Nb is accessible to read and write operations initiated by the master CPU 102 and the slave CPU 104. Write access can be forbidden for both processors 102, 104 while the secure controller 402 is running.

A register ADR1 is the base address of the data memory 126 of the master CPU 102. In receiving mode, the ADR1 register stores the first address location of the data memory 126 that the secure controller 402 will read. In emission mode, the register ADR1 stores the first address location that the secure controller 402 will write. The last address read or written will be “ADR1+Nb−1.”

A register ADR2 is the base address of the data memory 114 of the slave CPU 104. In emission mode, the register ADR2 stores the first address location of the data memory 114 that the secure controller 402 will read. In receiving mode, the register ADR2 stores the first address location that the secure controller 402 will write. The last address to be read or written will be “ADR2+Nb−1.”

Registers ADR2ₘₐₓ ADR2ₘᵢₙ represent high and low addresses (“limits”) of the data memory 114, respectively. These limits are accessible in read and write modes to the slave CPU 104 only. These limits allow the slave CPU 104 to define a memory window in the data memory 114 which will be reserved for the secure controller 402 during a data transfer. During data transfer, any fault injected into the current address to make it point outside the memory window defined by the contents of registers ADR2ₘₐₓ ADR2ₘᵢₙ can be detected by the secure controller 402 and reported through the violation register 406, and/or other security action taken by one or both of the processors 102, 104 or the security controller 402.

For security reasons, the control and status register 408 of the master CPU 102 can be written and read by the master CPU 102, but read only by the slave CPU 104. Likewise, the control and status register 410 of the slave CPU 104 can be written and read by the slave CPU 104, but read only by the master CPU 102. When the master CPU 102 is ready to transfer data to the slave CPU 104, the master CPU 102: sets the base address ADR1 in data memory 126; sets the number of bytes Nb to be transferred or emitted; and sets a direction bit MDIR to indicate a direction of data transfer from the master CPU 102 to the slave CPU 104. The master CPU 102 then sends a transfer request to the slave CPU 104 by setting the MRQ bit and MDIR bit (e.g., set to “1”) in the control & status register 408. Setting the MRQ and MDIR bits causes an interrupt of the slave CPU 104 to be automatically triggered to inform the slave CPU 104 that a request from the master CPU 102 is pending. The slave CPU 104 can then fill the ADR2ₘₐₓ ADR2ₘᵢₙ registers, and set the transfer enable bit STEN in the control & status register 408 to start the data transfer.

In emission mode, the slave CPU 104 sets the ADR2, ADR2ₘₐₓ, ADR2ₘᵢₙ/ and Nb registers and sets the SDIR bit in the control & status register 410. The slave CPU 104 then sends a transfer request to the master CPU 102 by setting the SRQ bit in the control & status register 410. Setting the SRQ and SIR bits causes an interrupt of the master CPU to be automatically triggered to inform the master CPU 102 that a transfer request from the slave CPU 104 is pending. The master CPU 102 can then read the Nb register, set the ADR1 register and set the transfer enable bit MTEN in the control & status register 110 to start the data transfer.

In some implementations, the security violation register 406 in the secure communication interface 108, which is accessible by the processors 102, 104, can be used to report security violations. Security violations can occur, for example, when both MTEN and STEN are set (e.g., set to “1”) or both MDIR and SDIR are set (e.g., set to “1”). These example bit states represent security violations because the bit states indicate that the processors 102, 104 have attempted to perform a data transfer at the same time. Other bit states using various numbers of bits are also possible.

In emission and receiving mode, the secure controller 402 can start the data transfer (e.g., when one of MTEN or STEN is set) if a rule set is complied with. Otherwise, a security violation can be triggered and the current data transfer can be automatically aborted. An example rule set can include a first rule that the slave base address ADR2 must be located in the memory window defined by ADR2ₘₐₓ, ADR2ₘᵢₙ, and a second rule that “ADR2+Nb” must be less than ADR2ₘₐₓ. Other rule sets are also possible including rule sets with more or fewer rules.

In some implementations, the secure controller 402 can include an internal counter (not shown). When a data transfer starts, the internal counter (which is not accessible to the processors 102, 104) counts the number of data transferred and triggers a security violation if the counter exceeds Nb. A security violation can be generated if during the data transfer, the current address of the data memory 114 of the slave CPU 104 is higher than ADR2ₘₐₓ or higher than “ADR2+Nb” or lower than ADR2ₘᵢₙ.

Thus, a fault injected during the configuration of the secure controller 402 or during data transfer will be detected through the violation register 406 in the secure communication interface 108. The slave CPU 104 can disable the data transfer operation using the “transfer enable” signal described in reference to FIG. 4, which can be generated by the secure controller 402. These security features protect the data transfer against attacks on the base address ADR2, on the number of bytes to transfer Nb and on the current address used during the data transfer.

In some implementations, data values that are subject to data transfer are not protected. For such implementations, the data values can be protected using a data signature mechanism, which can be implemented using a communication protocol, as described below.

### Master CPU-Slave CPU Communication Protocol

Data packets exchanged between processors 102, 104 through the secure controller 402 can follow a data format that, in some implementations, includes at least three fields. A first field is Data Length. The Data Length field defines the number of data that are subject to data transfer. A second field is Data Content. The Data Content field includes the data values to be transferred. A third field is Data Signature. The Data Signature field (e.g., a Cyclic Redundancy Check (CRC) field) represents the signature of the combined Data Length and Data Content fields. The command type can be part of the Data Content field. After checking the request (e.g., checking the data signature of the Data Length and Content fields), the slave CPU 104 generates an acknowledge flag (e.g., a flag stored in shared status register 404) reporting the result of the request checking. If the request checking is successful, the slave CPU 104 processes the request and returns the result of the processing through the secure communication interface 108.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims. For example, each claim can recite a separate implementation and combinations of claims can recite separate implementations.

What is claimed is:

1. A system comprising:
a first processor operable to perform operations associated with data stored in a first memory accessible by the first processor;
a second, secure processor operable to perform operations associated with data stored in a second memory accessible by the second processor, the second processor further operable to disable data transfer operations;
a secure communication interface coupled to the first processor and the second processor, the secure communication interface comprising:
a secure controller operable to transfer data between the first memory and the second memory, and to prevent the first processor from directly reading or modifying sensitive data in the second memory.

2. The system of claim 1, where the secure controller is further operable to prevent the second processor from directly reading or modifying data in the first memory.

3. The system of claim 1, where the secure controller is a Direct Memory Access controller.

4. The system of claim 1, where the secure communication interface further comprises:
a security violation register accessible to the first and second processors, the security violation register operable to report security violations associated with data transfer by the system.

5. The system of claim 1, where the secure controller is controlled at least in part by a first control register, the first control register operable to represent a number of bytes in a data transfer, the first control register accessible by the first and second processors.

6. The system of claim 5, where the secure controller is controlled at least in part by a second control register operable to store a first base address location of the first memory storing data to be transferred to the second memory by the secure controller.

7. The system of claim 6, where the secure controller is controlled at least in part by a third control register operable to store a second base address location of the second memory where data received from the secure controller will be stored.

8. The system of claim 7, where the secure controller is controlled at least in part by a fourth control register operable to store a minimum memory address and a maximum memory address defining a window in the second memory for storing data received from the secure controller.

9. The system of claim 1, where the first processor is associated with a first control and status register operable for controlling data transfer from the first memory to the second memory, and the second processor is associated with a second control and status register operable for controlling data transfer from the second memory to the first memory.

10. The system of claim 9, where the first or second control and status register includes one or more bits representing a data transfer request or a data transfer direction, or enables a data transfer between the first and second memories.

11. The system of claim 1, where the system is a smart card.

12. A method of providing secure data transfer between a first memory accessible by a first processor and a second memory accessible by a second, secure processor in a multi-processor system, where the first processor and the second processor are coupled together by a secure controller, the method comprising:
receiving at the secure controller a data transfer request from the first processor;
verifying that the data transfer request is targeted for a memory window defined in the second memory;
verifying that the amount of data to be transferred is less than or equal to a size of the memory window; and
if the data transfer request is targeted for the memory window and the amount of data to be transferred is less than or equal to the size of the memory window, transferring the data from the first memory to the memory window defined in the second memory.

13. The method of claim 12, where the data transfer follows a predefine data format that includes at least three fields, a first field operable to define a number of data that are subject to the data transfer, a second field operable to include data values subject to the data transfer, and a third field operable to include a data signature that represents a signature of the first and second fields.

14. The method of claim 12, where the secure controller is operable to transfer data between the first memory and the second memory, and to prevent the first processor from directly reading or modifying data in the second memory.

15. The method of claim 14, where the secure controller is further operable to prevent the second processor from directly reading or modifying data in the first memory.

16. The method of claim 12, where the secure controller is a Direct Memory Access controller.

17. A system comprising:
means for receiving at a secure controller a data transfer request from a first processor;
means for verifying that the data transfer request is targeted for a memory window defined in a second memory accessible by a second, secure processor coupled to the secure controller;
means for verifying that the amount of data to be transferred is less than or equal to the memory window; and
means for transferring the data from a first memory accessible by the first processor to the memory window defined in the second memory, where the transferring occurs if the data transfer request is targeted for the memory window and the amount of data to be transferred is less than or equal to the memory window.
